(19) United States
(12) Patent Application Publication
(10) Pub. No.: US 2006/0160051 A1
(43) Pub. Date: Jul. 20, 2006

(54) Educational lunch bag with question and answer indicia

(76) Inventor: Nancy Trowbridge-Kitchens, Boca Raton, FL (US)

Correspondence Address: ROBERT C. KAIN, JR., 750 SOUTHEAST THIRD AVENUE, SUITE 100, FT LAUDERDALE, FL, 333161153, US

(21) Appl. No.: 11/036,309

(22) Filed: Jan. 14, 2005

(51) Int. Cl. G09B 25/06; G09B 19/00; G09B 19/02; G09B 3/00

(52) U.S. Cl. 434/130; 434/156; 434/188; 434/322

(57) ABSTRACT

The education apparatus includes a disposable bag adapted to carry food stuffs. Indicia formed as an educational question is imprinted on one region on the side of the bag and responsive indicia representing an answer to the question is imprinted on the bottom of the bag. Alternatively, a kit for an educational apparatus consists of a two-part self adhering label separable from a label substrate. The two-part label has a first and a second label imprinted region with the first label region containing indicia formed as an educational question and the second label region containing indicia representing an answer. The consumer removes the respective labels and places them on the side of the bag and the bottom of the bag to form an educational apparatus for the school aged children or the inquisitive adult.

The present invention relates to an educational apparatus, namely, a lunch bag or a bag adapted to carry food stuffs which contains educational questions and answers imprinted as indicia thereon or affixed via thereon.

### BACKGROUND OF THE INVENTION

Disposable bags typically carry food stuffs and consumers oftentimes carry their lunch in such disposable bags which are sometimes identified herein as “lunch bags.” More importantly, school aged children oftentimes bring lunch and/or snacks to school in such lunch bags (that is, a disposable bag). There is an opportunity to expand the child's education by utilizing the typically blank space on the lunch bag. Inquisitive adults may also find such educational tools useful.

### OBJECTS OF THE INVENTION

It is an object of the present invention to provide an educational lunch bag with question and answer indicia.

It is another object of the present invention to provide an educational apparatus consisting of a disposable bag and an imprinted question on one side of the bag and an imprinted answer on the bottom side of the bag.

It is a further object of the present invention to provide a label system which can be affixed to a disposable bag, wherein those labels contain question indicia and corresponding answer indicia.

### SUMMARY OF THE INVENTION

The education apparatus includes a disposable bag adapted to carry food stuffs. Indicia formed as an educational question is imprinted on one region on the side of the bag and responsive indicia representing an answer to the question is imprinted on the bottom of the bag. Alternatively, a kit for an educational apparatus consists of a two-part self adhering label separable from a label substrate. The two-part label has a first and a second label imprinted region with the first label region containing indicia formed as an educational question and the second label region containing indicia representing an answer. The consumer removes the respective labels and places them on the side of the bag and the bottom of the bag to form an educational apparatus for the school aged children or the inquisitive adult.

### BRIEF DESCRIPTION OF THE DRAWINGS

Further objects and advantages of the present invention can be found in the detailed description of the preferred embodiments when taken in conjunction with the accompanying drawings in which:

FIG. 1 diagrammatically illustrates a lunch bag and particularly the uprising sides of the lunch bag;

FIG. 2 diagrammatically illustrates the bottom of the lunch bag;

FIG. 3 diagrammatically illustrates a two-part label; and,

FIG. 4 diagrammatically illustrates a plurality of disposable bags packaged as a unit for sale to a consumer.

### DETAILED DESCRIPTION OF THE PREFERRED EMBODIMENTS

The present invention relates to an educational apparatus or a kit assembled as an educational apparatus.

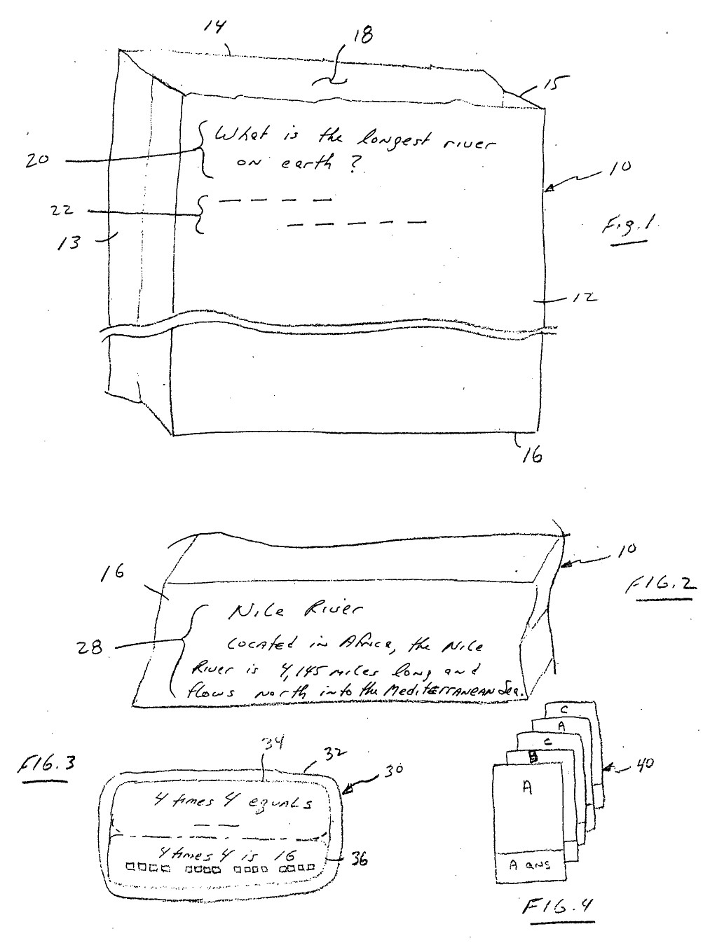

FIG. 1 diagrammatically illustrates a disposable bag, sometimes commonly called a lunch bag 10. Bag 10 includes four uprising sides 12, 13, 14, 15 and a bottom 16 and an open top 18. On bag side 12, region 20 has an educational question imprinted thereon. The educational question may be taken from topics including, but not limited to, geography, vocabulary, math, science, English and other language arts such as foreign language. In region 22, side 12 contains a plurality of lines representing a clue correlated to the correct answer to the question imprinted in region 20. Another words, the question shown in FIG. 1 “What is the longest river on earth?” is associated with an answer “Nile River” which has 9 letters consisting of 4 letters in the first group and 5 letters in the second group. Region 22 on side 12 shows 4 lines in the first group and five lines in the second group which provides the operator (a child or an inquisitive adult) a clue as to the correct answer to the question in region 20.

FIG. 2 diagrammatically shows the bottom 16 of bag 10. In region 28, the answer is imprinted therein corresponding to the question in region 20. Accordingly, the child at lunch or at snack time (or the adult in a similar situation) would read the question in region 20, attempt to guess the correct answer, possibly print the answer in region 22, and thereafter, lift the bag thereby exposing answer region 28 on bottom 16 of bag 10.

FIG. 3 shows a label 30. Label 30 includes label substrate 32 and a two-part self adhering label 34, 36. Label region 34 includes, imprinted thereon, an educational question whereas label region 36 includes, imprinted thereon, an answer associated with the question in label region 34. In operation, the user removes label region 34 representing the question and places it in region 20 on bag 10. The user then removes label region 36 and places it on bottom 16 of bag 10. In this manner, an educational apparatus is obtained from the kit which includes a plurality of two-part self-adhering labels 30 and a plurality of bags.

It is currently contemplated that a plurality of bags, such as 50 or 100 bags would be sold as a unit to a consumer. There would be a plurality of different questions imprinted on those bags or provided by labels for those bags. For school aged children in kindergarten and grade 1, it is estimated that 20 questions would be used per 100 bag package. For school aged children in 2-12 grades, there would be 50-100 questions per 100 bag package.

FIG. 4 diagrammatically shows a plurality of bags 40 wherein two of the bags carry question A, one bag carries question B, and two of the bags carry question C. Of course, each respective bag contains an answer (“Ans”) correlated to the question A, B or C. The plurality of bags 40 (50 count or 100 count) would be sold to the consumer as a unit.

It is also contemplated that the questions would be published in group such as Spring 2005, Summer 2005 and Fall 2005. By having repetitive questions in each consumer unit and by changing the questions through the seasons, the school aged children and inquisitive adults remain attentive to the questions and answers.

The claims appended hereto are meant to cover modifications and changes within the scope and spirit of the present invention.

What is claimed is:

1. An educational apparatus comprising:
a disposable bag adapted to carry food stuffs, said bag having a bottom, four uprising sides attached to said bottom and an open top;
indicia formed as an educational question imprinted in a region on one of said sides of said bag; and
responsive indicia representing an answer to said question imprinted on said bottom of said bag.

2. An educational apparatus as claimed in claim 1 including a plurality of lines representing a clue correlated to said answer, said plurality of lines imprinted adjacent said imprinted question region on said side of said bag.

3. An educational apparatus as claimed in claim 1 wherein said disposable bag is one of a plurality of disposable bags packaged as a unit for sale to a consumer, a first sub-plurality of bags in said unit imprinted with a first educational question and representative answer and a second sub-plurality of bags in said unit imprinted with second educational question and representative answer.

4. An educational apparatus as claimed in claim 3 wherein said educational questions are topically related to geography, vocabulary, math, science, English and language arts.

5. An educational apparatus as claimed in claim 1 wherein said disposable bag is one a plurality of bags, said plurality of bags having imprinted thereon a plurality of educational questions and representative answers which are topically related to geography, vocabulary, math, science, English and language arts.

6. An educational apparatus as claimed in claim 2 wherein said disposable bag is one of a plurality of disposable bags packaged as a unit for sale to a consumer, a first sub-plurality of bags in said unit imprinted with a first educational question and representative answer and a second sub-plurality of bags in said unit imprinted with second educational question and representative answer.

7. An educational apparatus as claimed in claim 6 wherein said educational questions are topically related to geography, vocabulary, math, science, English and language arts.

8. An educational apparatus as claimed in claim 6 wherein said plurality of bags having imprinted thereon a plurality of educational questions and representative answers which are topically related to geography, vocabulary, math, science, English and language arts.

9. A kit assembled as an educational apparatus comprising:
a disposable bag adapted to carry food stuffs, said bag having a bottom, four uprising sides attached to said bottom and an open top;
a two-part self-adhering label separable from a label substrate, said two-part self-adhering label having a first and a second label imprinted region, both label regions separable from each other and from said label substrate;
indicia formed as an educational question imprinted on said first label region, said first label region adapted to be mounted on one of said sides of said bag; and
responsive indicia representing an answer to said question imprinted on said second label region and adapted to be mounted on said bottom of said bag.

10. A kit assembled as an educational apparatus-as claimed in claim 9 wherein said first label region includes a plurality of imprinted lines representing a clue correlated to said answer.

11. A kit assembled as an educational apparatus as claimed in claim 9 wherein said two-part adhering label is one of a plurality of labels, each imprinted with a different question and corresponding answer.

12. A kit assembled as an educational apparatus as claimed in claim 11 wherein said educational questions are topically related to geography, vocabulary, math, science, English and language arts.
